(19) United States
(12) Patent Application Publication
(10) Pub. No.: US 2006/0227263 A1
(43) Pub. Date: Oct. 12, 2006

(54) Polarizing plate with adhesive and liquid crystal display

(75) Inventor: Yuichiro Kunai, Niihama-shi (JP)

Correspondence Address: FOLEY AND LARDNER LLP;SUITE 500, 3000 K STREET NW, WASHINGTON, DC, 20007, US

(73) Assignee: SUMITOMO CHEMICAL COMPANY, LIMITED

(21) Appl. No.: 11/384,813

(22) Filed: Mar. 21, 2006

(30) Foreign Application Priority Data
Mar. 24, 2005 (JP) 2005-085670

(51) Int. Cl. G02F 1/1335

(52) U.S. Cl. 349/96

(57) ABSTRACT

A polarizer having an adhesive where light-leakage can be reduced in comparison with the prior art when set on a liquid crystal display is provided, and furthermore, a liquid crystal display where light-leakage have been reduced using the same is provided. A polarizer 30 having an adhesive which is laminated to a liquid crystal cell 40 for use and provided with a polarizing plate 10 and a pressure sensitive adhesive layer 20, where the thickness of pressure sensitive adhesive layer 20 which faces at least liquid crystal cell 40 is not less than 10 μm and less than 20 μm, is provided.

### BACKGROUND OF THE INVENTION

1. Field of the Invention

The present invention relates to a polarizing plate with an adhesive that is used for a liquid crystal display screen, and a liquid crystal display thereof. The present invention also relates to a method for preventing from generating light-leakage when a polarizing plate is set on a liquid crystal display.

2. Description of the Related Art

In recent years, light weight and thin liquid crystal displays having a low level of power consumption and operating with a low voltage have been spreading rapidly as information displaying devices such as cellular phones, portable information terminals, monitors for computers and TV sets. With the development of liquid crystal technology, various types of liquid crystal displays have been proposed, whereby solving problems with liquid crystal displays, such as low speed of response, poor contrast and narrow range of viewing angles. In these conventional liquid crystal displays, however, local light leakage occurs when black is displayed due to effects of the surrounding environment and the heat source, for example, a backlight.

Such local light leakage is caused by the expansion and contraction of oriented polymer films, such as polarizing plates and phase retarders, which are attached to a liquid crystal cell, caused by the surrounding environment and localized heat. Oriented polymer films such as polarizing plates and phase retarders are generally laminated to liquid crystal displays, and the films considerably expand and contract, due to the change in the environment.

In order to reduce such local light leakage, various types of pressure sensitive adhesives (also referred to as adhesives) have been used, and two types can be cited.

One type is pressure sensitive adhesives having a low elastic modulus (soft-type), and this type freely changes in form, without resisting the contractive force of polarizing plates, so as to prevent the occurrence of stress. JP 9 87593 A (corresponding to U.S. Pat. No. 5,795,650), for example, describes that local light leakage in polarizing plates can be reduced by using a soft pressure sensitive adhesive. Many of such soft-type pressure sensitive adhesives have such low durability that they are stripped from a polarizing plate during the contraction of the polarizing plate or the like. In particular, in large-scale liquid crystal displays, the amount of contraction in a polarizing plate becomes large, and according by stripping usually occur.

The other type is pressure sensitive adhesives having a high elastic modulus (hard-type), and this type suppresses contraction altogether in polarizing plates, so that these never move, and thereby, keep the region where stress occurs to the minimum. JP 2003-207637 A, for example, described that the thickness of a polarizing film of a polyvinyl alcohol resin film is reduced, and protective films are laminated to both surfaces of the polarizing film to obtain a polarizing plate, and thereby, it is possible to use a relatively hard-type pressure sensitive adhesive. Hard-type pressure sensitive adhesives require a very strong force to peel from glass, and therefore, in reworking after pasting a film to a liquid crystal cell, for example, if, for some reason, it becomes necessary to peel a film after it has been laminated to a liquid crystal cell, in many cases, the work of peeling this film and pasting another film becomes difficult.

A variety of proposals have been made for suppressing local light leakage, from points of view other than those of pressure sensitive adhesives, and JP 2002-174729A, for example, describes that a protective film of an amorphous polyolefin resin is laminated to one surface of a polarizing film of a polyvinyl alcohol resin film, and a protective film made of a resin that is different from the above described amorphous polyolefin resin is laminated to the other surface, and thereby generation of, light-leakage can be suppressed.

### SUMMARY OF THE INVENTION

The present inventors have conducted research in order to reduce the occurrence of local light leakage as that described above in liquid crystal displays. As a result, they have discovered that local light leakage which tends to occur as a result of change in the environment or the heat source, for example, a backlight, can be prevented in liquid crystal displays by setting the thickness of the pressure sensitive adhesive for pasting a polarizing plate for mounting on a liquid crystal display to a liquid crystal cell to a predetermined thickness, and thus, the present invention was achieved.

Therefore, an object of the present invention is to provide a polarizing plate with an adhesive which can reduce local light leakage, in comparison with the prior art, when it is mounted on a liquid crystal display. Another object of the present invention is to provide a liquid crystal display where local light leakage is prevented by using such a polarizing plate with an adhesive. Still another object of the present invention is to provide a method for suppressing occurrence of local light leakage when a polarizing plate is mounted on a liquid crystal display.

The present invention provides a polarizer comprising a polarizing plate and a pressure sensitive adhesive layer, wherein the thickness of the pressure sensitive adhesive layer which faces a liquid crystal cell is not less than 10 μm and less than 20 μm.

In addition, the present invention provides a liquid crystal display where the polarizing plate as described above is laminated to a liquid crystal cell on the side of the pressure sensitive adhesive layer having a thickness of not less than 10 μm and less than 20 μm.

Furthermore, the present invention provides a method for suppressing the occurrence of light-leakage when a polarizer comprising polarizing plate and a pressure sensitive adhesive layer is mounted on a liquid crystal display, wherein, when the polarizer in which the polarizing plate that is formed of a polymer film is laminated to a liquid crystal cell, the film thickness of the pressure sensitive adhesive layer for making the liquid crystal cell and the polarizing plate adhere to each other is set to not less than 10 μm and less than 20 μm, so that expansion and contraction of the polymer film is prevented.

In a polarizer having an adhesive of the present invention, the pressure-sensitive adhesive layer which faces the liquid crystal cell side is made to be not less than 10 μm and less than 20 μm, and thereby, local light leakage which tends to occur as a result of the effects of the surrounding environment and the heat source, for example, a backlight, can be effectively reduced, whereby providing excellent display quality, when the polarizer is mounted on a liquid crystal display. In addition, the polarizer having an adhesive requires little force to peel from the liquid crystal cell and can be peeled easily, in comparison with those of which the pressure sensitive adhesive layer is not less than 20 μm, and therefore, there is the advantage that it is possible to use an adhesive of a hard type.

### BRIEF DESCRIPTION OF THE DRAWINGS

FIG. 1 is a schematic cross sectional diagram showing one example of the configuration of a polarizer having an adhesive;

FIG. 2 is a schematic cross sectional diagram showing another example of the configuration of a polarizer having an adhesive;

FIG. 3 is a schematic cross sectional diagram showing a state where a polarizer having an adhesive is mounted on a liquid crystal cell;

FIG. 4 is a copy of a photograph showing light-leakage in the liquid crystal display that has been fabricated in Example 1;

FIG. 5 is a copy of a photograph showing light-leakage in the liquid crystal display that has been fabricated in Comparative Example 1;

FIG. 6 is a copy of a photograph showing light-leakage in the liquid crystal display that has been fabricated in Example 2; and

FIG. 7 is a copy of a photograph showing light-leakage in the liquid crystal display that has been fabricated in Comparative Example 2.

### DESCRIPTION OF THE PREFERRED EXAMPLES

In the following, the embodiments of the present invention are described in detail, in reference to the corresponding accompanying drawings.

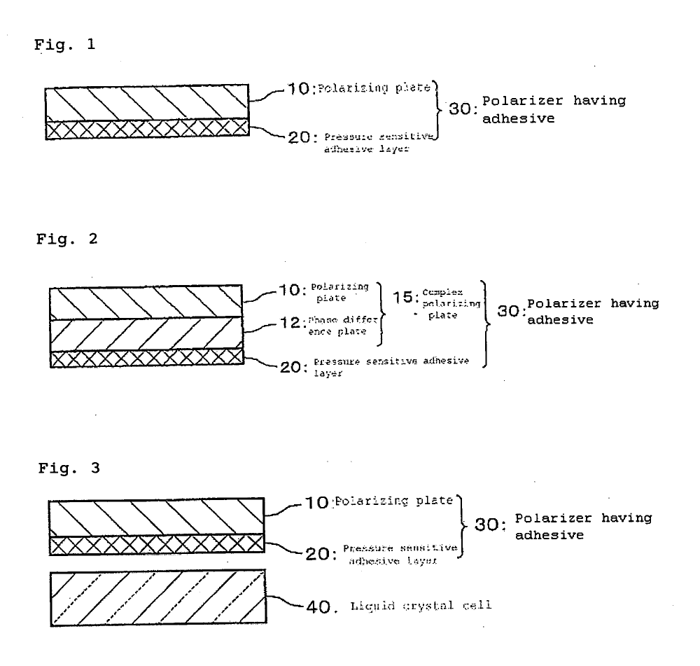

According to the present invention, as shown in FIG. 1, a polarizing plate 10 and a pressure sensitive adhesive layer 20 are placed on top of each other, so that a polarizer 30 having an adhesive is provided. Though pressure sensitive adhesive layers may be provided on both sides of polarizing plate 10 in the case where pasting to other members is necessary, according to the present invention, the thickness of pressure sensitive adhesive layer 20 on the side that faces a liquid crystal cell is not less than 10 μm and less than 20 μm.

The thickness of pressure sensitive adhesive layer 20 on the side which faces a liquid crystal cell is made less than 20 μm, because the smaller the thickness is, the smaller the amount of change in the form of the adhesive becomes, and thereby, contraction of the polymer film, for example, a polarizing plate, can be suppressed. While the thickness of pressure sensitive adhesive layer of polarizing plates with an adhesive which are presently distributed on the market is not less than 20 μm, concretely, 25 μm or 30 μm, the thickness is made less than 20 μm, whereby reducing the force necessary to peel it from glass, and therefore, reworking becomes possible, even in the case where an adhesive of a hard-type, which has so far made rework difficult, is used.

In the case where the thickness is made too small, however, an appearance of display may be deteriorated, since it may be difficult to hide some deflects that occur at the time of the application of an adhesive, or a foreign substance that has mixed in. In addition, in the case where the thickness becomes small and exceeds a certain threshold, the fluctuation in the force necessary for peeling from glass generally becomes large, due to the unevenness in the thickness, and therefore, it becomes difficult to stably obtain products having the required force necessary for peeling. Furthermore, in the case where the thickness is made too small, the force required for peeling from glass becomes too small, and a durability may become lower. For this reason, the thickness of pressure sensitive adhesive layer 20 is made not less than 10 μm.

Polarizing plate 10 may be a polarizing plate where a protective layer made of a film of triacetyl cellulose or a norbornene resins is placed on one or both sides of a conventionally used polarizing film where a two-color pigment made of iodine or a two-color organic dye has been absorbed by a polyvinyl alcohol resin film so as to be oriented, a polarizing plate where a phase retarder is used instead of a protective layer on one side, or a polarizing plate where a phase retarder is further laminated to any of these via a pressure sensitive adhesive or a water soluble adhesive, a so-called complex polarizing plate.

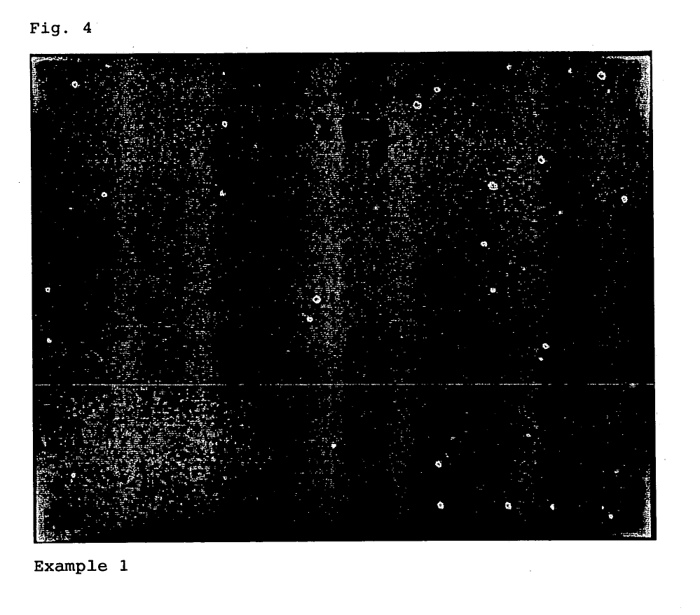

FIG. 2 shows the configuration of a so-called complex polarizing plate in the case where a phase retarder is laminated to a polarizing film or the protective layer of a polarizing plate. As shown in this diagram, a pressure sensitive adhesive layer 20 is formed on a complex polarizing plate 15 in a state where a polarizing plate 10 and a phase retarder 12 are laminated together, so that a polarizer 30 having an adhesive can be provided. In this case, a pressure sensitive adhesive layer 20 for pasting to a liquid crystal cell is provided on the outside of phase retarder 12. In other words, phase retarder 12 is generally placed between pressure sensitive adhesive layer 20 and polarizing plate 10. A phase retarder and a polarizing film or a protective layer may be laminated together via a pressure sensitive adhesive, and in such a case, at least two of pressure sensitive adhesive layers exist on the side of the polarizing plate which faces a liquid crystal cell, one between the polarizing plate and the phase retarder, and the other on the outside of the phase retarder. As described above, in the case where a number of pressure sensitive adhesive layers exist on the side of the polarizing plate that faces a liquid crystal cell, the pressure sensitive adhesive layer that is laminated directly to a liquid crystal cell may have a thickness of not less than 10 μm and less than 20 μm, as defined according to the present invention.

As phase retarder 12, oriented films, such as of polycarbonate, polyallylate, polysulfone, polyether sulfone, cellulose based resins and annular polyolefin based resins, of which the monomers are norbornene, are used. Among these, oriented films of resins of which the absolute value of the photoelastic coefficient is not greater than 50×10⁻¹³ cm²/dyne, such as modified cellulose resins and cyclic polyolefin resins, are preferable. In addition, films where an application layer made of a liquid crystal substance or the like is provided on a transparent resin substrate, such as cellulose based resins, so that a phase retardance is exhibited may be used.

A pressure sensitive adhesive which forms pressure sensitive adhesive layer 20 is also referred to as an adhesive, and adhesives of which the base polymers are acryl based polymers, silicone based polymers, polyester, polyurethane, polyether or the like can be used. Among these, it is preferable to select and use an adhesive such as acryl pressure sensitive adhesives, which is highly optically transparent, has appropriate wettability and aggregation, has excellent adhesiveness to the base, and is weather resistant and heat resistant, such that there is no peeling problem, such as lifting off and peeling, under the conditions of heating and humidification. In acryl pressure sensitive adhesives, acryl copolymers of which the weight average molecular weight is not less than 100,000, where alkyl ester of acrylic acid having an alkyl group, such as a methyl group, an ethyl group or a butyl group, of which the carbon number is not greater than 20, and an acryl based monomer that contains a functional group made of (meta) acrylic acid or hydroxy ethyl (meta)acrylate are mixed so that the glass transition temperature becomes preferably not higher than 25° C., more preferably not higher than 0° C., are useful as the base polymer.

The formation of a pressure sensitive adhesive layer on a polarizing plate can be carried out using a system according to which, for example, a pressure sensitive adhesive composition is dissolved or dispersed in an organic solvent, such as toluene or ethyl acetate, so that a solution of which the concentration is approximately 10 wt % to 40 wt % is prepared, and this is applied directly to a polarizing plate or a complex polarizing plate so as to form a pressure sensitive adhesive layer, or using a system according to which a pressure sensitive adhesive layer is formed on a protective film in advance and this is laminated to a polarizing plate or a complex polarizing plate so as to form a pressure sensitive adhesive layer.

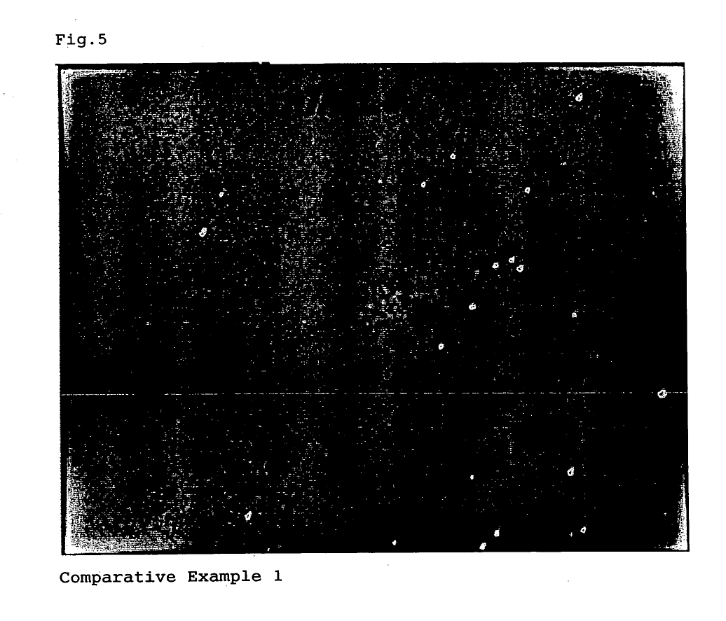

A polarizer having an adhesive according to the present invention is advantageous when applied to a liquid crystal display. FIG. 3 is a schematic cross sectional diagram showing the configuration when a polarizer having an adhesive according to the present invention is mounted on a liquid crystal display. As shown in this diagram, a pressure sensitive adhesive layer 20 in a polarizer 30 having an adhesive is laminated to a liquid crystal cell 40, so that a liquid crystal display is obtained. While FIG. 3 shows the configuration when a polarizer having an adhesive having the configuration shown in FIG. 1 is laminated to a liquid crystal cell, a polarizer having an adhesive having the configuration where a pressure sensitive adhesive layer is formed on a complex polarizing plate as that shown in FIG. 2 can, of course, be laminated to a liquid crystal cell, and in this case also, the pressure sensitive adhesive layer 20 side in FIG. 2 is laminated to a liquid crystal cell. In the case where there is only one pressure sensitive adhesive layer on a surface side of polarizing plate 10, the thickness of this layer is made not less than 10 μm and less than 20 μm according to the present invention, and this pressure sensitive adhesive layer is laminated to liquid crystal cell 40. Meanwhile, in the case where there are a number of pressure sensitive adhesive layers on the side of polarizing plate 10 that is to be laminated to liquid crystal cell 40, as described above, the thickness of the pressure sensitive adhesive layer which is laminated directly to a liquid crystal cell among these pressure sensitive adhesive layers is made not less than 10 μm and less than 20 μm.

The type of liquid crystal cell that forms the liquid crystal display is not particularly limited, and the same liquid crystal cells as those used in a variety of well-known systems can be used. These systems may be, for example, a system where liquid crystal in a cell is located parallel to the substrate and twisted by approximately 90° in a state where no voltage is applied, and the liquid crystal is oriented in the direction approximately perpendicular to the cell substrate when a voltage is applied, so that polarized light that passes through this liquid crystal layer is blocked or transmitted for display (twisted nematic mode; TN mode), a system where liquid crystal in a cell is oriented perpendicular to the substrate in a state where no voltage is applied, and the orientation of the liquid crystal changes when a voltage is applied, so that the state of polarization of light that passes through this liquid crystal layer changes for display (vertical alignment mode; VA mode), a system where liquid crystal in a cell is oriented parallel to the substrate in a state where no voltage is applied, and the orientation of the liquid crystal is changed by applying a voltage in the lateral direction, so that the state of polarization of light that passes through this liquid crystal layer changes for display (in-plane switching mode; IPS mode) or the like.

According to the present invention, the thickness of the pressure sensitive adhesive layer that is laminated to a liquid crystal cell is set to a small value, and thereby, the adhesiveness of this pressure sensitive adhesive layer to a liquid crystal cell is made relatively small. Therefore, even in the case where a polymer film, such as a polarizing plate, expands and contracts, due to change in the temperature of its environment or the heat source, for example, a backlight, the accompanying stress can be relieved to a certain degree, and accordingly, local light leakage, which tends to occur in the periphery of the display due to such stress, can be effectively suppressed. Especially in the case of large-scale liquid crystal displays, the amount of expansion and contraction in polymer films becomes large, and therefore, the present invention is particularly effective for liquid crystal displays of a large scale, for example, those having a diagonal length of not less than 15 inches (approximately 38 cm), more so if not less than 17 inches (approximately 43 cm), and even more so if not less than 19 inches (approximately 48 cm).

In the case where a polarizer is laminated to one surface of a liquid crystal cell via a pressure sensitive adhesive layer of which the thickness is not less than 10 μm and less than 20 μm, while the polarizer that is placed on the other side of the liquid crystal cell is not particularly limited according to the present invention, pasting of polarizer to both surfaces of a liquid crystal cell via pressure sensitive adhesive layers of which the film thickness is not less than 10 μm and less than 20 μm is more effective for the prevention of local light leakage according to the present invention.

### EXAMPLES

In the following, the present invention is described more concretely by showing examples, but the present invention is not limited to these examples.

### Example 1

An acryl pressure sensitive adhesive [“P-0082,” made by Lintec Corporation] was applied to a polarizing plate [“SR-N442A,” made by Sumitomo Chemical Co., Ltd.] where a triacetyl cellulose protective film was laminated to one surface of a polyvinyl alcohol-iodine polarizing film, and a modified cellulose phase retarder was laminated to the other surface, on the phase retarder side so as to have a thickness of the adhesive of 15 μm, so that a polarizer having an adhesive was obtained. This polarizer was cut into chips having an appropriate size for use with commercially available VA mode liquid crystal cells (made by Samsung Corporation) having a diagonal length of 17 inches (approximately 43 cm), and the chips were laminated to the top and bottom of a liquid crystal cell. The obtained liquid crystal display was exposed to a dry atmosphere of 80° C. for 89 hours, and after that, made to display black, and a copy of a photograph of this is shown in FIG. 4.

### Comparative Example 1

An acryl pressure sensitive adhesive “P-0082,” which is the same as that used in Example 1 was applied to a polarizing plate “SR-N442A,” which is the same as that used in Example 1, on the phase retarder side so as to have a thickness of the adhesive of 25 μm, so that a polarizer having an adhesive was obtained. Such polarizing plates with an adhesive were laminated to the top and bottom of a VA mode liquid crystal cell that is the same as that used in Example 1. The obtained liquid crystal display was exposed to a dry atmosphere of 80° C. for 89 hours, and after that, made to display black, and a copy of a photograph of this is shown in FIG. 5.

While the pressure sensitive adhesive “P-0082” that is used in Example 1 and Comparative Example 1 is a type with which relatively few light-leakage are created, strong light-leakage appeared in the four corners in Comparative Example 1 (FIG. 5), where the thickness of the pressure sensitive adhesive layer was 25 μm after being exposed to a high temperature environment for a long period of time. In contrast, though the same type of pressure sensitive adhesive was used, light-leakage were reduced, and an excellent appearance of display condition was maintained, in comparison with Comparative Example 1, in Example 1 (FIG. 4), where the thickness of the pressure sensitive was 15 μm, even after being exposed to a high temperature environment for a long period of time.

### Example 2

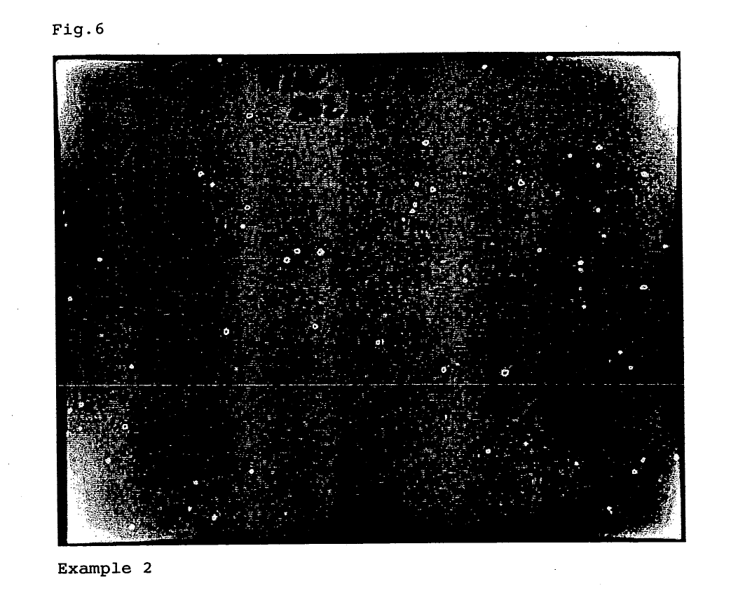

A different type of acryl pressure sensitive adhesive (“P-3132,” made by Lintec Corporation) was applied to the same type of polarizing plate “SR-N442A” as that used in Example 1, on the phase retarder side so as to have a thickness of the adhesive of 15 μm, so that a polarizer having an adhesive was obtained. Such polarizer were laminated to the top and bottom of the same type of VA mode liquid crystal cell as that used in Example 1. This liquid crystal display was exposed to a dry atmosphere of 80° C. for 89 hours, and after that, made to display black, and a copy of a photograph of this is shown in FIG. 6.

### Comparative Example 2

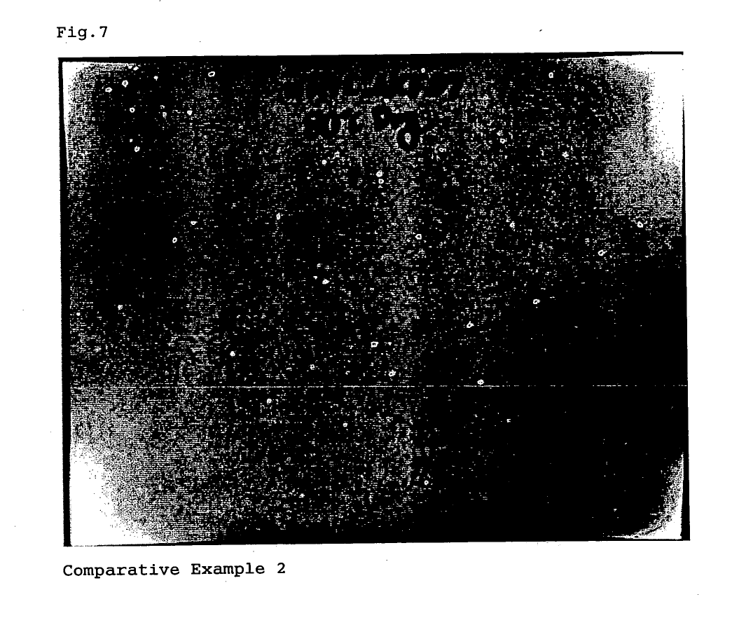

The same type of acryl pressure sensitive adhesive “P-3132” as that used in Example 2 was applied to the same type of polarizing plate “SR-N442A” as that used in Example 1, on the phase retarder side so as to have a thickness of the adhesive of 25 μm, so that a polarizer having an adhesive was obtained. Such polarizer were laminated pasted to the top and bottom of the same type of VA mode liquid crystal cell as that used in Example 1. This liquid crystal display was exposed to a dry atmosphere of 80° C. for 89 hours, and after that, made to display black, and a copy of a photograph of this is shown in FIG. 7.

The pressure sensitive adhesive “P-3132” which was used in Example 2 and Comparative Example 2 is of a type which easily causes light-leakage, and in Comparative Example 2 (FIG. 7), where the thickness of the pressure sensitive adhesive was 25 μm, light-leakage were observed over a wide range after being exposed to a high temperature environment for a long period of time. In contrast, in Example 2 (FIG. 6), where the same type of pressure sensitive adhesive was used and the thickness thereof was 15 μm, light-leakage were reduced in comparison with Comparative Example 2, even after being exposed to a high temperature environment for a long period of time.

### Example 3

An acryl pressure sensitive adhesive [“P-0082,” made by Lintec Corporation] was applied to a polarizing plate [“SR-N542A-SL6,” made by Sumitomo Chemical Co., Ltd.] having a total thickness of 196 μm, where a triacetyl cellulose protective film was laminated to one surface of a polyvinyl alcohol-iodine polarizer, and a modified cellulose phase retarder was laminated to the other surface, on the phase retarder side so as to have a thickness of the adhesive of 15 μm, so that a polarizer having an adhesive was obtained. This polarizer was cut into a strip having a width of 25 mm, which was then laminated to a soda glass plate on which a pressure and heat applying process was carried out under 5 atm at 50° C. for 20 minutes and left undisturbed for one day, and after that, a 180 degree peeling test (holder moving speed: 300 mm/min) was carried out, according to JIS K 6854-2 (which corresponds to ISO 8510-2), using an auto-graph. The peeling force at this time was 16.3 N, and the peeling force was small, in comparison with the case where the same type of pressure sensitive adhesive having a thickness of 25 μm was provided, as shown in the below described Comparative Example 3, and it was found that excellent reworkability was obtained. A sample having a diagonal length of 17 inches (approximately 43 cm) was actually laminated to a commercially available VA mode liquid crystal cell (made by Samsung Corporation), and a heat and pressure applying process was carried out under 5 atm at 50° C. for 20 minutes, and then, the sample was left undisturbed for 14 days, and a rework test was carried out, and it was found that the sample could be easily peeled.

### Comparative Example 3

The same type of acryl pressure sensitive adhesive “P-0082” as that used in Example 3, was applied to one surface of a polarizing plate [“SR-W842A-SL6,” made by Sumitomo Chemical Co., Ltd.] having a total thickness of 196 μm, where triacteyl cellulose protective films were laminated to both surfaces of a polyvinyl alcohol-iodine polarizer, so as to have a thickness of the adhesive of 25 μm, so that a polarizer having an adhesive was obtained. This polarizer was cut into a strip having a width of 25 mm and laminated to a soda glass plate, on which a heat and pressure applying process was carried out under 5 atm at 50° C. for 20 minutes, and then, the sample was left undisturbed for one day, and the same type of 180 degree peeling test as that in Example 3 was conducted, using an autograph. The peeling force at this time was 31.1 N, which is very strong, and it was found that reworkability was poor. A sample having a diagonal length of 17 inches (approximately 43 cm) was actually laminated to the same type of commercially available VA mode liquid crystal cell as that used in Example 3, on which a pressure and heat applying process was carried out under 5 atm at 50° C. for 20 minutes, and then, the sample was left undisturbed for 14 days, after which a rework test was conducted, and it was found that the sample was difficult to peel.

1. A polarizer comprising a polarizing plate and a pressure sensitive adhesive layer, wherein the thickness of the pressure sensitive adhesive layer at least which faces a liquid crystal cell is not less than 10 μm and less than 20 μm.

2. The polarizer according to claim 1, which has a phase retarder between the pressure sensitive adhesive layer and the polarizing plate.

3. A liquid crystal display comprising the polarizer according to claim 1, wherein the polarizer laminated to a liquid crystal cell on the side of the pressure sensitive adhesive layer having a thickness of not less than 10 μm and less than 20 μm.

4. The liquid crystal display according to claim 3, wherein a liquid crystal cell has a diagonal length of not less than 15 inches.

5. A method for suppressing the light-leakage when a polarizing plate is set on a liquid crystal display, the method comprising pasting a polarizing plate of a polymer film to a liquid crystal cell, wherein the thickness of the pressure sensitive adhesive layer for making the polarizing plate and the liquid crystal cell adhere to each other is set to not less than 10 μm and less than 20 μm.
